(19) United States
(12) Patent Application Publication
(10) Pub. No.: US 2010/0171629 A1
(43) Pub. Date: Jul. 8, 2010

(54) SIGNAL TOWER AND INTEGRATION SYSTEM USING THE SAME

(76) Inventor: Myung Jin Lee, Chungcheongnam-do (KR)

Correspondence Address: CHRISTOPHER PAUL MITCHELL, 888 16TH ST., NW, SUITE 800, WASHINGTON, DC, 20006, US

(21) Appl. No.: 12/664,393

(22) PCT Filed: Jun. 12, 2008
(86) PCT No.: PCT/KR08/03307

§ 371 Date: Dec. 12, 2009

(30) Foreign Application Priority Data
Jun. 13, 2007 (KR) 10-2007-0057718
Feb. 11, 2008 (KR) 10-2008-0012234

(51) Int. Cl. G08B 5/00

(52) U.S. Cl. 340/691.6

(57) ABSTRACT

A signal tower is installed on a body of a manufacturing equipment and having lamps for displaying operational states of the manufacturing equipment through lighting of various colors. The signal tower comprises a frame formed with a display window; and a display device installed in the display window of the frame to display colors and letters in response to a control signal from a computer.

### TECHNICAL FIELD

The present invention relates to a signal tower for displaying the operational state of a manufacturing equipment using colors and letters and an integration system using the same, and more particularly, to a signal tower which can display the current operational state of a manufacturing equipment for manufacturing semiconductors, LCDs, etc. using colors and letters so that visibility is improved, can automatically report the occurrence of an emergency such as a fire to a fire station and an administrator, and can allow the situation and the position of the fire to be checked through a monitor, and an integration system using the same.

### BACKGROUND ART

In order to manufacture semiconductors, LCDs, etc., a number of equipment are needed. These equipments automatically conduct specified processes in response to the manipulation from an administrator. Products such as semiconductors, LCDs, etc. having undergone the specified processes are moved through subsequent processes as the occasion demands.

The processing equipments for manufacturing products can perform a diagnosis function for detecting abnormal operation during processes and defects in equipments. By the diagnosis function, abnormal operation during processes or defects in equipments can be easily checked.

If an abnormality is checked in equipment or a process, a signal tower installed in the corresponding equipment or the corresponding process line is lighted to display the occurrence of the abnormality.

Referring to FIGS. 1 and 2, this kind of alarm device is generally composed of a signal tower 2 which is installed on the body of manufacturing equipment 4.

The signal tower 2 is usually installed on the front surface or the upper end of the manufacturing equipment 4 and displays the operational state of the manufacturing equipment 4 by lighting lamps.

The signal tower 2 is divided, depending upon the way of installation thereof, into an independent support type signal tower 2-1 which is installed on a support rod 12 mounted to a mounting block 14, and a wall attachment type signal tower 2-2 which is installed on the wall of the manufacturing equipment 4.

The signal tower 2 is composed of a plurality of lamps 10 which can display the operational states of the manufacturing equipment 4 using various colors. Here, among these lamps, an error lamp 10a indicates the erroneous operational state of the manufacturing equipment 4, a run lamp 10b indicates the normal operational state of the manufacturing equipment 4, and an idle lamp 10c indicates the standby state of the manufacturing equipment 4. In general, the error lamp 10a has the color of red, the run lamp 10b has the color of green, and the idle lamp 10c has the color of yellow.

A buzzer (not shown) can be provided to the signal tower 2 so as to generate alarm sounds when the lamps 10 are lighted.

If an error occurs in the manufacturing process of the manufacturing equipment 4 in operation, the error lamp 10a is lighted. At this time, when an administrator views the error lamp 10a, he or she can take necessary measures immediately or after interrupting the operation of the manufacturing equipment 4.

When the necessary measures for the manufacturing equipment 4 have completely been taken, the corresponding manufacturing equipment 4 is initialized again to conduct the interrupted process.

However, in the conventional signal tower 2, the operational states of the manufacturing equipment 4 can be recognized only through the colors of the lighted lamps. Therefore, if the administrator does not pay enough attention to the lamps, the abnormal operational state cannot be immediately grasped by the administrator.

Also, even when the administrator recognizes the lighting of the lamp on the signal tower, inconvenience is caused in that the administrator must recollect the meaning of the color. In order to cope with this problem, a method of attaching stickers having words printed thereon, such as “Run”, “Idle” and “Error” has been disclosed in the art. Nevertheless, in this case, since the lamps are partially covered by the stickers, it is difficult for the administrator to properly see the lighted states of the lamps.

Moreover, if a fire breaks out in the manufacturing equipment, a report to a fire station should be separately made, and since it is difficult to immediately grasp the situation of the fire, necessary measures cannot be quickly taken.

Further, as sounds generated by various signal towers are different from one another, confusion is likely to be caused.

### DISCLOSURE OF INVENTION

### Technical Problem

Accordingly, the present invention has been made in an effort to solve the problems occurring in the related art, and an object of the present invention is to provide a signal tower which can display not only colors but also letters so that visibility is improved.

Another object of the present invention is to provide an integration system which can detect and automatically report the occurrence of an emergency in manufacturing equipment, and can allow the current situation and the position of the corresponding manufacturing equipment to be checked through a monitor.

### Technical Solution

In order to achieve the first object, according to one aspect of the present invention, there is provided a signal tower installed on a body of a manufacturing equipment and having a plurality of lamps for displaying operational states of the manufacturing equipment through lighting of various colors, the signal tower comprising a frame formed with a display window; and a display device installed in the display window of the frame to display colors and letters in response to a control signal from a computer.

According to another aspect of the present invention, the display device comprises a display panel for displaying colors and letters in response to a signal, and a printed circuit board for the signal tower, installed to allow the colors and the letters to be displayed on the display panel in response to an electric signal.

According to another aspect of the present invention, any ones of colors and letters or both colors and letters are displayed on the display panel.

According to another aspect of the present invention, colored letters are displayed on the display panel.

According to another aspect of the present invention, the signal tower further comprises an MP3 so that a melody can be selected.

According to another aspect of the present invention, the operational state of the corresponding manufacturing equipment can be directly inputted to the display panel using the computer.

According to another aspect of the present invention, the display panel comprises any one of an LED panel, an LCD panel, and a rollable LCD panel.

According to another aspect of the present invention, the signal tower is formed by stacking message blocks on which colors and letters are displayed.

According to another aspect of the present invention, the signal tower further includes an additional function block which is stacked on the message blocks and is capable of radio reception and photographing.

According to another aspect of the present invention, the message block comprises a hexahedral frame which is formed with a display window, a printed circuit board for a signal tower, which has an emergency battery, and a display panel which is installed in the display window to display colors or letters.

According to another aspect of the present invention, the frame comprises display windows which are formed on a side surface of the frame so that display panels can be installed in the display windows, an assembly groove which is defined on an upper surface of the frame to allow the frame to be assembled with another frame, and an insertion part which projects on a lower surface of the frame to allow the frame to be assembled with still another frame.

According to another aspect of the present invention, an emergency battery is connected to the printed circuit board for a signal tower so that a power failure state of the manufacturing equipment can be displayed.

According to another aspect of the present invention, the additional function block comprises at least one of a radio reception block which is formed by installing a radio receiver on a printed circuit board and a photographing block which is formed by installing a camera on a printed circuit board.

In order to achieve the object, there is provided a signal tower integration system comprising equipment checking means for displaying an operational state of a manufacturing equipment using a signal tower; message sending means for sending messages; fire reporting means for automatically reporting the occurrence of a fire to a fire station; position tracking means communicating with a radio receiver of the signal tower to confirm a position of the corresponding manufacturing equipment and a position of an administrator; Internet monitoring means for monitoring and recording an emergency situation of the manufacturing equipment; and control means for controlling a main server for receiving and processing signals from the means, in a central control room.

### Advantageous Effects

Thanks to the above-described features, the signal tower according to the present invention can display the operational state of manufacturing equipment for manufacturing semiconductors, LCDs, etc. using colors and letters so that visibility is improved.

Since the operational state of the corresponding manufacturing equipment can be directly inputted to a computer, the operational state can be transmitted within a short period.

An emergency situation can be monitored in real time through the Internet.

When an emergency situation such as a fire breaks out, because the occurrence of the fire can be reported to a fire station through an integration system, personal and property losses can be minimized.

In the case that the signal tower integration system is linked with an earthquake broadcast system, it is possible to take precautions against earthquakes and take shelter quickly.

Colors and letters can be clearly displayed employing an LED panel, an LCD panel, and a rollable LCD panel.

Sounds can be unified for all manufacturing equipment employing any one of an MP3, a buzzer, a melody chip, whereby confusion can be avoided.

When a fire breaks out in manufacturing equipment, a message is sent to an administrator, and it is possible to take necessary measures while watching the scene of the fire through a monitor.

The camera of the signal tower can be checked in real time by accessing the Internet.

Due to the provision of an emergency battery, a power failure message can be displayed on the signal tower, and therefore, necessary measures can be quickly taken following a power failure.

### BRIEF DESCRIPTION OF THE DRAWINGS

FIG. 1 is a view illustrating a conventional signal tower for manufacturing equipment.

FIG. 2 is a view illustrating a scheme for controlling the signal tower shown in FIG. 1.

FIG. 3 is a perspective view illustrating manufacturing equipment on which a signal tower in accordance with the present invention is installed.

FIG. 4 is a perspective view illustrating the signal tower shown in FIG. 3.

FIG. 5 is a view illustrating the configuration of a display device which is installed in the signal tower shown in FIG. 4.

FIGS. 6(a) through 6(e) are views illustrating the exemplary uses of the signal tower shown in FIG. 4.

FIGS. 7(a) through 7(c) are views illustrating other embodiments of the signal tower shown in FIG. 4.

FIGS. 8(a) and 8(b) are views illustrating other embodiments of the signal tower shown in FIG. 4.

FIG. 9 is a partially exploded perspective view illustrating another embodiment of the signal tower shown in FIG. 4.

FIG. 10 is a side view illustrating the signal tower shown in FIG. 9.

FIG. 11 is a view illustrating a stack type signal tower as another embodiment of the signal tower shown in FIG. 9.

FIGS. 12(a) through 12(d) are views illustrating the situation display examples of the independent support type signal tower shown in FIG. 9 and a wall attachment type signal tower.

FIG. 13 is a view illustrating a basic scheme for controlling the signal tower in accordance with the present invention.

FIG. 14 is a block diagram illustrating the configuration of an integration system using the signal tower in accordance with the present invention.

FIG. 15 is a view schematically illustrating the exemplary location of the integration system in accordance with present invention with respect to manufacturing equipments in a factory.

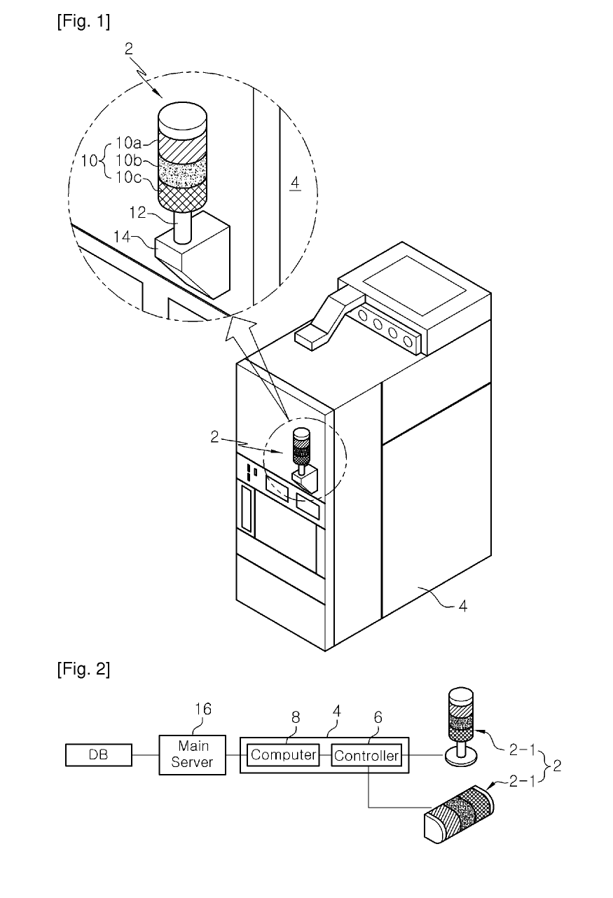

### BEST MODE FOR CARRYING OUT THE INVENTION

Reference will now be made in greater detail to preferred embodiments of the invention, examples of which are illustrated in the accompanying drawings. Wherever possible, the same reference numerals will be used throughout the drawings and the description to refer to the same or like parts.

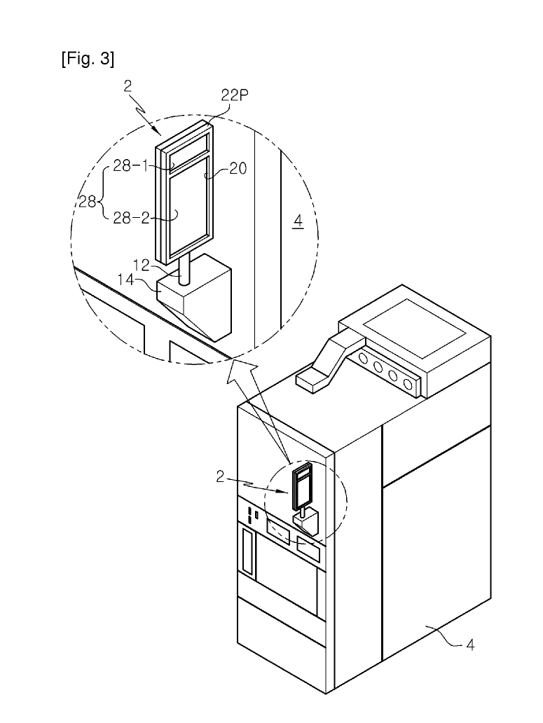

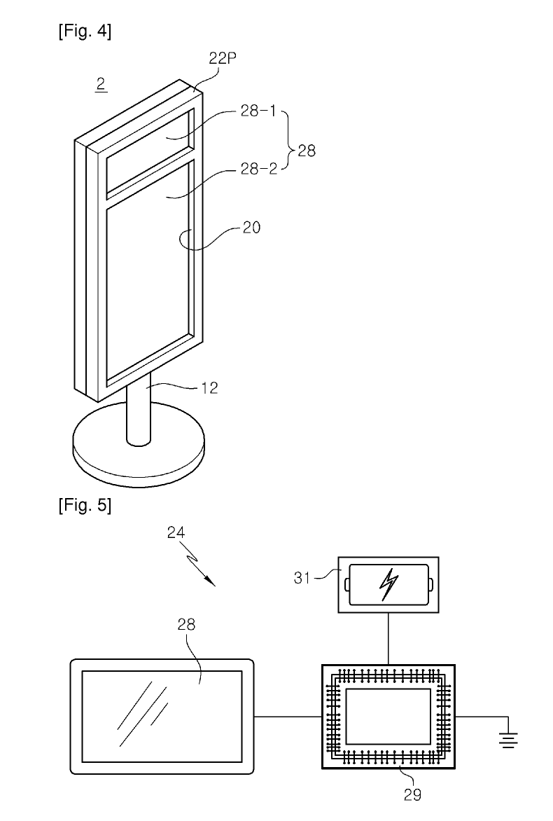

Referring to FIGS. 3 and 4, a signal tower 2 in accordance with the present invention is installed on manufacturing equipment 4 in the form of a frame 22P which is supported by a support rod 12 and is formed with a display window 20.

A display device 24 is installed in the display window 20 of the frame 22P as shown in FIG. 5, such that colors and letters can be displayed on a display panel 28 in response to a signal from a printed circuit board 29 which is controlled by a control signal from a computer.

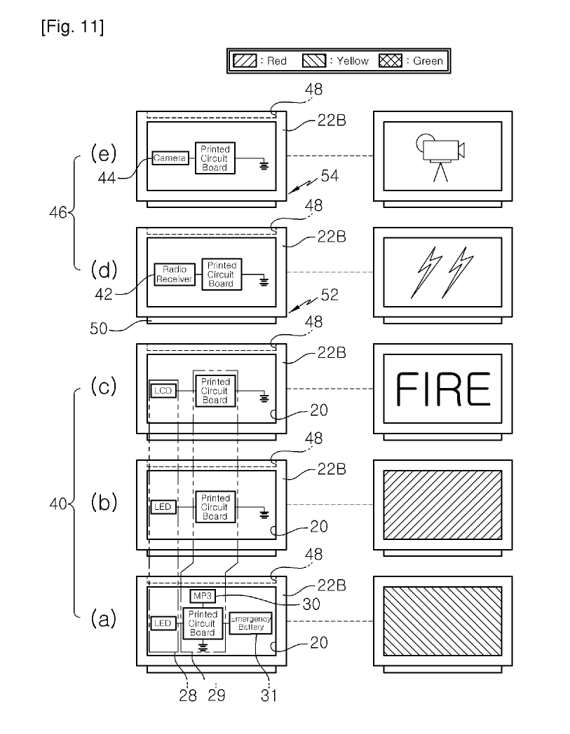

As shown in FIGS. 5 and 11, the display device 24 includes the display panel 28 which is installed in the display window 20, the printed circuit board 29 which displays the colors and the letters on the display panel 28 in response to the signal from the computer, and an emergency battery 31 which is provided to allow a power failure state to be displayed when a power failure is caused in the manufacturing equipment 4.

In the present invention, a frame 22 is generally divided into a single frame 22P and a stack type frame 22B. It is preferred that at least two display windows 20 are formed such that various colors and letters can be displayed.

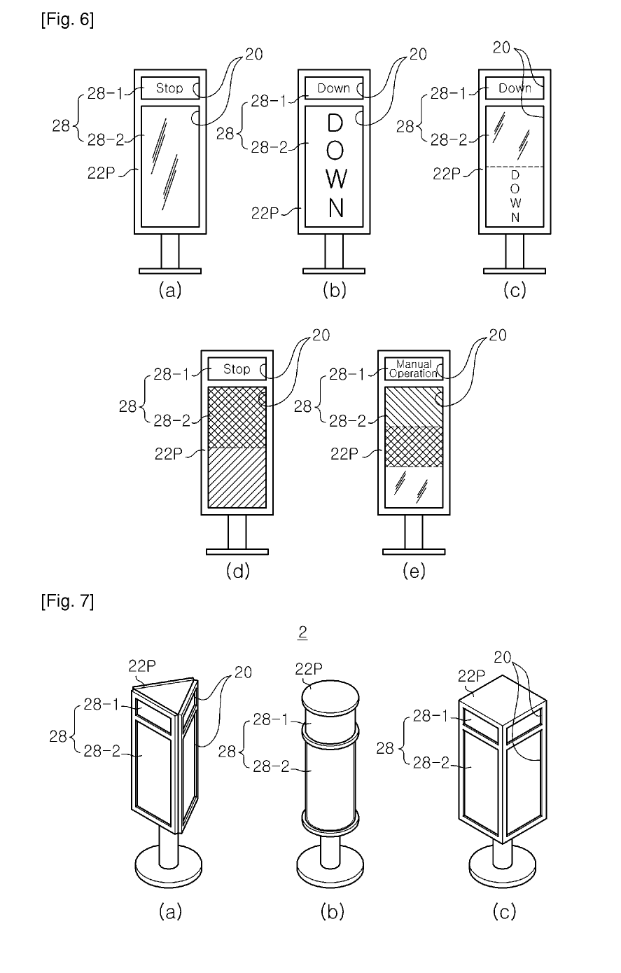

The frame 22 can be formed to have not only the shape of a rectangular panel as shown in FIG. 4 but also the shape of a trigonal prism (see FIG. 7(a)), a circular cylinder (see FIG. 7(b)) and a square pillar (see FIG. 7(c)). Further, the frame 22 can be formed in the shape of a trigonal pyramid, a circular cone, a quadrangular pyramid, etc.

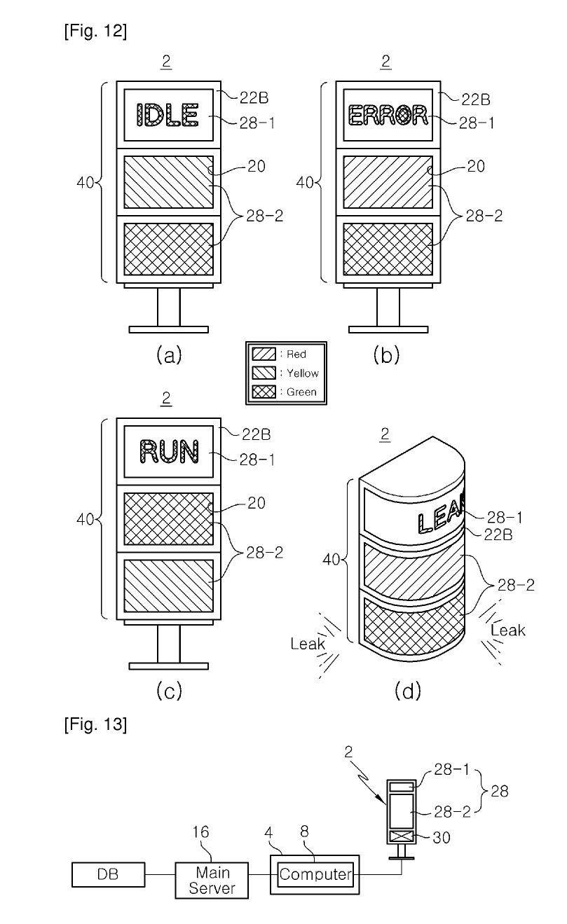

The frame 22 can be formed into an independent support type using a support rod and a wall attachment type as shown in FIG. 12(d) to be attached to the wall of the manufacturing equipment 4.

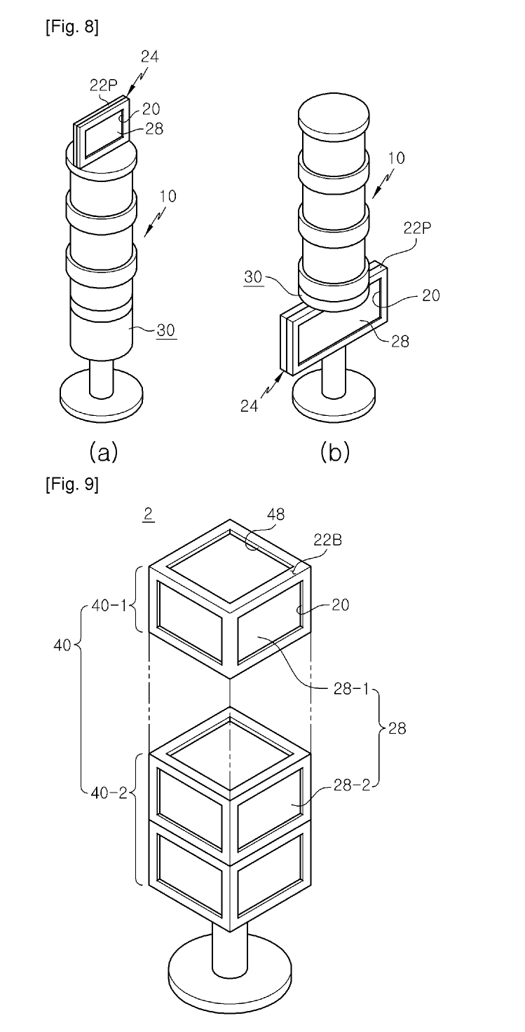

As shown in FIGS. 8(a) and 8(b), in the signal tower according to the present invention, a display device 24 can be additionally installed on the upper and lower ends of a conventional lamp type signal tower.

In the signal tower according to the present invention, an MP3 30 can be additionally installed thereon. The MP3 30 can set different melodies for respective words displayed on the signal tower 2. According to this, the contents displayed on the signal tower 2 can be immediately recognized by the melody produced by the MP3 30.

The MP3 30 on the signal tower can be independently installed as shown in FIGS. 8 and 13 or on the printed circuit board 29 as shown in FIG. 11.

Since the MP3 30 can select a melody, sounds can be unified for all manufacturing equipment. A melody chip (IC) may be installed in place of the MP3 30. In the event that several manufacturing equipments are installed in a single line, the MP3 30 or the melody chip allows an administrator or a worker to easily confirm that a melody or an alarm sound is produced from which manufacturing equipment.

The MP3 30 or the melody chip can be set to produce different melodies for the respective operational states of the manufacturing equipment. According to this, a worker can recognize the operational state of the corresponding manufacturing equipment only by hearing the melody produced by the MP3 30 or the melody chip.

Meanwhile, the display panel 28 of the display device 24 is installed in the frame 22P in the form of the display window 20 as shown in FIGS. 6 and 9.

As shown in FIGS. 3 through 8, the display panel 28 can display colors or letters on the respective entire surfaces thereof or by dividing the respective surfaces. The display panel 28 can be divided into a letter display panel 28-1 on which letters are displayed and a color display panel 28-2 on which colors are displayed.

Referring to FIGS. 6(a) through 6(e), the colors and the letters can be used in a manner such that an operational state is display on the letter display panel 28-1 using letters, and colors are displayed on the color display panel 28-2 in a variety of ways by a preset program.

That is to say, the entire color display panel 28-2 can be displayed with a color as shown in FIG. 6(a), or colored letters or other letters can be displayed on the color display panel 28-2 as shown in FIG. 6(b). Also, colors and letters can be simultaneously displayed by dividing the color display panel 28-2 into two portions as shown in FIG. 6(c), or only colors can be displayed by dividing the color display panels 28-2 into two or three portions as shown in FIGS. 6(d) and 6(e).

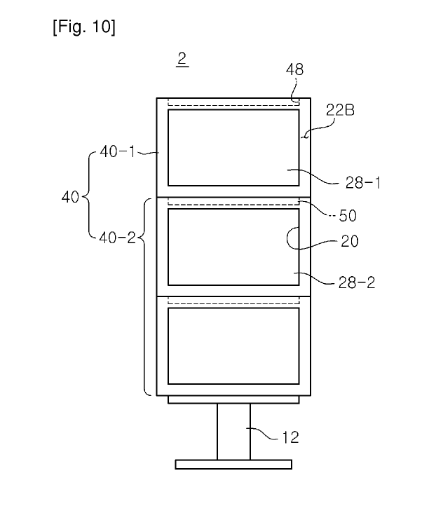

As shown in FIGS. 9 through 11, the display panel 28 is selectively installed in conformity with the uses of a letter block 40-1 and color blocks 40-2 which are formed by frames 22B.

Preferably, a 3.5″ TFT LCD is employed as the letter display panel 28-1, and an LED backlight is employed as the color display panel 28-2.

Referring to FIG. 12, in the signal tower 2, colors such as red, yellow and green can be used, and words such as “Run”, “Idle”, “Error” and “Leak” can be used. Besides, words for indicating various situations, which can be caused while conducting processes in the manufacturing equipment, can be used.

For the letters or words, English or other languages including Korean can be used. As the occasion demands, any one language can be selectively used. Also, by using different colors for the respective words indicating the operational states of the manufacturing equipment, visibility can be further improved.

Referring to FIGS. 9 through 11, the signal tower 2 can be configured in the shape of a plurality of message blocks 40 which are structured by stacking frames 22B each formed in the shape of a box.

The message blocks 40 have one letter block 40-1 for displaying letters and two color blocks 40-2 for displaying colors.

Referring to FIG. 11, in the signal tower 2, function blocks 46 can be added to the message blocks 40. The additional function blocks 46 comprise blocks in which a radio receiver 42 and a camera 44 are respectively installed. While the additional function blocks 46 are stacked on the message blocks 40, the positions of the additional function blocks 46 can be changed as desired.

The message blocks 40 are formed by mounting the letter display panel 28-1 and the color display panels 28-2 in the display windows 20 of frames 22B which function to support the display panels 28. In each frame 22B, display windows 20 are formed on the respective outer surfaces of the frame 22B, excluding the upper and lower end surfaces of the frame 22B on which other frames 22B are stacked, so that the display panels 28 can be viewed from all angles.

In each frame 22B, an assembly groove 48 and an insertion part 50 are respectively formed on the upper and lower ends of the frame 22B. The assembly groove 48 and the insertion part 50 ensure easy stacking of the blocks. Connectors (not shown) are provided to the assembly groove 48 and the insertion part 50 so that blocks can be electrically connected with one another. The frame 22B can be formed to have the outer shape of a hexahedron, a circular cylinder, a trigonal prism, a trigonal pyramid, a board, and so forth.

The display device 24 as shown in FIG. 5 is installed in the frame 22B. The emergency battery 31 is basically installed in the display device 24 so that power can be supplied to the printed circuit board in an emergency situation. The MP3 30 is arranged in any one of the message blocks 40.

The additional function blocks 46 are composed of a radio reception block 52 and a photographing block 54. The radio receiver 42 is disposed in the radio reception block 52, and the camera 44 is disposed in the photographing block 54.

The radio reception block 52 is stacked on the upper end of the message blocks 40. It is preferred that the radio reception block 52 need not to be stacked on all signal towers 2 and be installed with an interval of about 10 m.

The radio receiver 42 receives and reads a signal transmitted from a card which is possessed by an administrator or a worker, and informs a main server 16 of the position of the administrator or the worker.

The photographing block 54 is installed on the upper end of the message blocks 40 such that the camera 44 faces another camera 44 disposed in another photographing block 54. Upon occurrence of an emergency situation, the camera 44 can automatically record a scene in response to a signal from the main server 16. The image recorded by the camera 44 is stored in the main server 16 such that it can be monitored from anywhere through the Internet.

Referring to FIG. 11, the signal tower can be used by stacking the message blocks 40 and the additional function blocks 46 in the sequence of (a), (b), (c), (d) and (e). The installation of the additional function blocks 46 can be omitted as the occasion demands.

As the signal tower 2 informs the administrator of the operational state of the manufacturing equipment using colors, letters and a melody, it simultaneously outputs an electric signal to the main server 16.

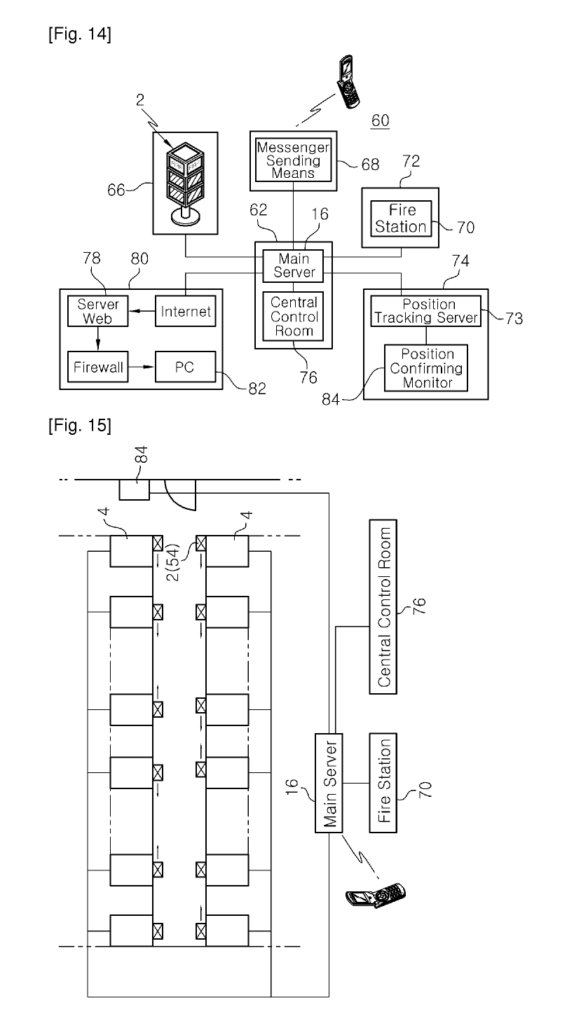

If the main server 16 recognizes the emergency state of the manufacturing equipment through the signal tower 2, a signal tower integration system 60 as shown in FIG. 14 is actuated.

The signal tower integration system 60 includes a signal tower 2 serving as equipment sensing means 66 for sensing an operational error in the manufacturing equipment, a fire, etc., and control means 62 for receiving information from the equipment sensing means 66 and performing a control function. The control means 62 has the main server 16 and a central control room 76.

The main server 16 recognizes the emergency situation through the electric signal from the signal tower 2. The main server 16 recognizes the emergency situation of the manufacturing equipment by a preset program and sends a message to the administrator through message sending means 68.

If the main server 16 recognizes the occurrence of a fire through the electric signal from the signal tower 2, it automatically reports the occurrence of the fire to a fire station 70 by fire reporting means 72.

Further, the main server 16 is always provided with the positions of the administrator of the corresponding equipment and persons present in a factory, through a position tracking server 73 of position confirming means 74 which communicates with the radio receiver 42 installed in the signal tower 2.

When the emergency situation of the manufacturing equipment is recognized by the main server 16, the central control room 76 sends a message to the administrator and the persons and administrates the emergency situation.

The signal tower integration system 60 further includes Internet monitoring means 80 such that the main server 16 can be accessed through the Internet. According to this, the main server 16 can be connected with an outside PC 82 through the Internet via a web server 78.

Hence, the emergency situation of the manufacturing equipment can be monitored using the PC 82 from anywhere accessible to the Internet and can be recorded.

The main server 16 processes the signals inputted from the above-described means as data, and supplies the data to the central control room 76.

Hereafter, the operations of the signal tower and the integration system using the same according to the present invention, configured as described above, will be described with reference to FIGS. 12 through 15.

First, when the manufacturing equipment 4 is in the standby state for operation, as shown in FIG. 12(a), the word “IDLE” is displayed on the letter display panel 28-1 of the signal tower 2, and yellow and green are displayed up and down on the color display panels 28-2.

When the manufacturing equipment 4 is in an error state, as shown in FIG. 12(b), the word “ERROR” is displayed on the letter display panel 28-1 of the signal tower 2, and red and green are displayed up and down on the color display panels 28-2.

When the manufacturing equipment 4 is in a normal state, as shown in FIG. 12(c), the word “RUN” is displayed on the letter display panel 28-1 of the signal tower 2, and green and yellow are displayed up and down on the color display panels 28-2.

When the manufacturing equipment 4 is in a leaking state, as shown in FIG. 12(d), the word “LEAK” is displayed on the letter display panel 28-1 of the signal tower 2, and red and green are displayed up and down on the color display panels 28-2. At this time, a sound “LEAK” is produced by the MP3 30 which is installed in the message block 40.

Hereinbelow, the signal tower integration system 60 for integrally controlling the operational state of the manufacturing equipment 4 will be explained.

Referring to FIG. 11, in the signal tower 2, the radio reception block 52 for sensing the positions of the administrator and the persons present in the factory and the photographing block 54 for imaging the state of the manufacturing equipment are stacked. At this time, in FIG. 11, the cameras 44 of photographing blocks 54 are installed to face the directions indicated by the arrows so that photographing areas can be overlapped and there is no missing area.

If the signal tower 2 senses the occurrence of a fire in the manufacturing equipment 4, the word “FIRE” is displayed on the letter display panel 28-1, and red is displayed up and down on the color display panels 28-2.

As the main server 16 recognizes the occurrence of the fire through the signal tower 2, reporting is automatically made to the fire station by the fire reporting means 72.

If the fire occurs in the manufacturing equipment 4, the camera 44 photographs the scene of the fire occurring in the manufacturing equipment 4 in response to the control signal from the main server 16, and automatically records the scene of the fire and stores corresponding image data to the main server 16.

As the emergency situation occurs in the manufacturing equipment 4, the main server 16 sends a message informing the occurrence of the fire to the mobile phone of the administrator through the message sending means 68.

The main server 16 can confirm the positions of the administrator and the persons present in the factory by the radio receiver 42 of the signal tower 2. If the administrator and the persons present in the factory are at a dangerous site, the central control room 76 can send a message to the administrator and the persons, urging them to get out of the dangerous site.

The administrator and fire fighters reached the scene of the fire by receiving the message and the fire reporting can confirm and look over, through the position confirming monitor 84 installed at the entrance of the factory, the manufacturing equipment 4 in which the fire occurs. Therefore, they can easily find the position of the manufacturing equipment in which the fire occurs. As a consequence, the administrator and the fire fighters can quickly move to the position of the manufacturing equipment in which the fire occurs and can extinguish the fire at an early stage.

The main server 16 displays the positions of the administrator and the worker on the monitor 84 through the radio receiver 42 serving as the position tracking means 74.

Further, the emergency situation of the manufacturing equipment 4 can be monitored through the Internet via the camera 44 of the photographing block 54. In other words, the manufacturing equipment 4 can be monitored from everywhere the PC 82 is placed.

Since the main server 16 is controlled in real time from the central control room 76, it can be reliably managed. Also, when the integration system is linked with the earthquake broadcasting system, safety measures for the manufacturing equipment can be quickly taken.

### INDUSTRIAL APPLICABILITY

As is apparent from the above description, in the present invention, the operational states of manufacturing equipments can be precisely checked through the colors and letters displayed on signal towers. Further, when a fire breaks out, reporting, message transmission, position confirmation, and monitoring through the Internet can be controlled in an integrated manner. Therefore, the present invention can be widely applied to the field of systems for monitoring manufacturing equipments.

Although preferred embodiments of the present invention have been described for illustrative purposes, those skilled in the art will appreciate that various modifications, additions and substitutions are possible, without departing from the scope and spirit of the invention as disclosed in the accompanying claims.

1. A signal tower installed on a body of a manufacturing equipment and having lamps for displaying operational states of the manufacturing equipment through lighting of various colors, the signal tower comprising:
a frame formed with a display window; and
a display device installed in the display window of the frame to display colors and letters in response to a control signal from a computer.

2. The signal tower according to claim 1, wherein the display device comprises a display panel for displaying colors and letters in response to a signal, and a printed circuit board for the signal tower, installed to allow the colors and the letters to be displayed on the display panel in response to an electric signal.

3. The signal tower according to claim 2, wherein the printed circuit board is connected with an emergency battery to be supplied with emergency power in case of a power failure.

4. The signal tower according to claim 1, wherein the signal tower is formed by stacking message blocks in which display devices are installed in frames.

5. The signal tower according to claim 1, wherein the signal tower further includes an additional function block which is placed on the message blocks and is capable of radio reception and photographing.

6. The signal tower according to claim 5, wherein the additional function block comprises any one of a radio reception block in which a radio receiver is installed and a photographing block in which a camera is installed.

7. The signal tower according to claim 1, wherein the signal tower can comprise a desired number of message blocks and function blocks which are stacked upon one another.

8. The signal tower according to claim 1, wherein the signal tower is installed with a melody chip or an MP3 so that a melody can be selectively controlled.

9. The signal tower according to claim 1, wherein the signal tower further comprises a display device which is installed on lamps.

10. The signal tower according to claim 1, wherein the signal tower is connected with a computer so that letters can be directly inputted to the display panel.

11. The signal tower according to claim 2, wherein the display panel comprises any one of a LED panel, a LCD panel, and a rollable LCD panel.

12. The signal tower according to claim 1, wherein the frame comprises a polyhedron so that display panels can be viewed from several directions.

13. The signal tower according to claim 4, wherein the frame comprises display windows which are formed on a side surface of the frame so that display panels can be installed in the display windows, an assembly groove which is defined on an upper surface of the frame to allow the frame to be assembled with another frame, and an insertion part which projects on a lower surface of the frame to allow the frame to be assembled with still another frame.

14. A signal tower integration system comprising:
equipment checking means for displaying an operational state of a manufacturing equipment using a signal tower;
message sending means for sending messages;
fire reporting means for automatically reporting the occurrence of a fire to a fire station;
position tracking means communicating with a radio receiver of the signal tower to confirm a position of the corresponding manufacturing equipment and a position of an administrator;
Internet monitoring means for monitoring and recording an emergency situation of the manufacturing equipment; and
control means for controlling a main server for receiving and processing signals from the means, in a central control room. cm 15. The signal tower according to claim 4, wherein the frame comprises a polyhedron so that display panels can be viewed from several directions.
